(19) United States
(12) Patent Application Publication
(10) Pub. No.: US 2008/0231821 A1
(43) Pub. Date: Sep. 25, 2008

(54) Exposure Method Of A Semiconductor Device

(75) Inventor: Jong Hoon Kim, Seongnam-Si (KR)

Correspondence Address: MARSHALL, GERSTEIN & BORUN LLP, 233 S. WACKER DRIVE, SUITE 6300, SEARS TOWER, CHICAGO, IL, 60606, US

(73) Assignee: HYNIX SEMICONDUCTOR INC., Gyeonggi-do (KR)

(21) Appl. No.: 11/770,688

(22) Filed: Jun. 28, 2007

(30) Foreign Application Priority Data
Mar. 23, 2007 (KR) 10-2007-28576

(51) Int. Cl. G03B 27/54

(52) U.S. Cl. 355/30

(57) ABSTRACT

An exposure method of a semiconductor device includes the steps of: providing a wafer on which a photoresist is coated; rotating and aligning a reticle and the wafer so that a swing direction of a light source passing through the reticle is identical to a direction of a word line formed on the wafer; and performing an exposure process employing a polarized light source of an X direction, the polarized light source being generated by passing the light source through a dipole X-illumination system

### CROSS-REFERENCE TO RELATED APPLICATION

The priority of Korean patent application number 2007-28576, filed on Mar. 23, 2007, the disclosure of which is incorporated by reference in its entirety, is claimed.

### BACKGROUND OF THE INVENTION

The invention relates, in general, to an exposure method of a semiconductor device and, more particularly, to an exposure method of a semiconductor device capable of preventing pattern failure caused by a heated lens.

In general, semiconductor devices are formed in microstructure form in narrow spaces. Thus, an exposure process is inevitably needed for the manufacturing process of the semiconductor devices in order to form patterns. In this exposure process, the patterns are distorted depending on the size and/or shape of the patterns. Accordingly, in order to minimize distortion occurring upon exposure, small patterns are exposed using an exposure apparatus having better resolutions so as to form desired patterns. However, the method of exposing the patterns with an exposure apparatus having better resolutions generally requires a longer time to form the patterns.

For example, in the exposure of DRAM devices, the exposure of a repetitive pattern has been considered. In order to expose the pattern, a scanner or a stepper for photographing the entire pattern at a time with no regard to the pattern size has been used. In other words, a pattern for forming one chip is formed at a time. This method can be used without significant problems when the size of a pattern is large, but the method results in distortion when a pattern is complicated.

As described above, at the time of exposure when using a single exposure apparatus, the relationship between the pattern on the mask and the pattern on the wafer depends on a pattern to be exposed.

In flash memory semiconductor devices, a gate photo process has a very vulnerable process margin. In most cell mask processes, a pattern is formed from an X-direction mask, whereas a gate mask is includes a Y-direction cell mask. Accordingly, at the time of the mask process, an exposure apparatus equipped with a dipole X-illumination system is used.

The most important part of the exposure apparatus is the lens. At the time of the exposure process employing a laser source, there is a problem that the lens part is heated by an exposure laser as the wafer exposure proceeds. If the exposure lens is heated, the exposure process cannot be performed under optimal conditions (referred to as “best focus” conditions). Pattern failure can also result due to focus variations. Accordingly, in order to solve the problems, an attempt was made to secure stabilization through correction of the exposure apparatus.

A stabilization system is set to an X-direction cell mask. In the case of a scanner exposure apparatus, a scan progresses in the Y-direction and the scanner exposure apparatus is optimized only in the X-direction. Thus, this problem cannot be solved in the case of a Y-direction cell mask.

FIG. 1 is a graph illustrating focus variations when the dipole Y-illumination system is used.

From FIG. 1, an increasing number of wafers exposed when a gate mask process is performed causes the exposure focus to vary. If the dipole Y-illumination system is used in the exposure apparatus as described above, pattern failure occurs as the number of the wafers increases, as illustrated in FIG. 2. Consequently, pattern failure is generated depending on the progress of the lots as the wafer moves and device yield is lowered accordingly.

### SUMMARY OF THE INVENTION

Accordingly, the invention addresses the above problems and provides an exposure method of a semiconductor device in a gate photo process of a semiconductor device, an exposure process is performed using a dipole X-illumination system instead of a dipole Y-illumination system and the exposure process is also performed by rotating a reticle stage and a wafer stage for wafer alignment by 90 degrees, so that although the number of wafers is increased, the occurrence of pattern failure due to a heated lens can be prevented.

In an aspect, the invention provides an exposure method of a semiconductor device including the steps of: providing a wafer including a photoresist coated on the wafer; rotating and aligning a reticle and the wafer so that a swing direction of a light source passing through the reticle is aligned with a direction of a word line formed on the a wafer; and performing an exposure process employing a polarized light source of an X-direction, the polarized light source being generated by passing the light source through a dipole X-illumination system.

### BRIEF DESCRIPTION OF THE DRAWINGS

FIG. 1 is a graph illustrating focus variations when a dipole Y-illumination system is used;

FIG. 2 is a photograph showing pattern failure occurring as the number of wafers increases when the dipole Y-illumination system is used;

FIGS. 3A and 3B are graphs illustrating focus versus the number of wafers on which an exposure process has been performed when the dipole X-illumination system and the dipole Y-illumination system are used;

FIG. 4 illustrates an exposure apparatus according to an embodiment of the invention;

FIG. 5 is a view illustrating a state where a light source passes through the dipole X-illumination system;

FIG. 6 illustrates a state where a reticle stage has been rotated; and

FIG. 7 illustrates a state where a wafer stage has been rotated.

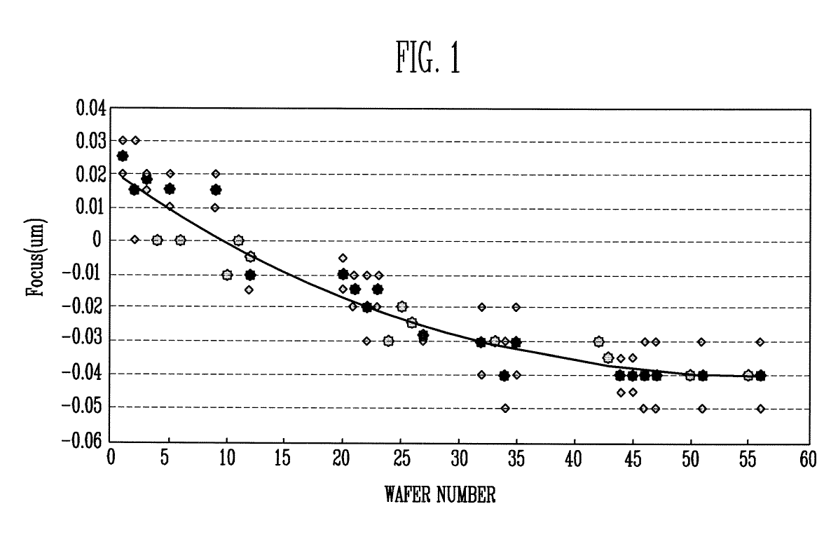

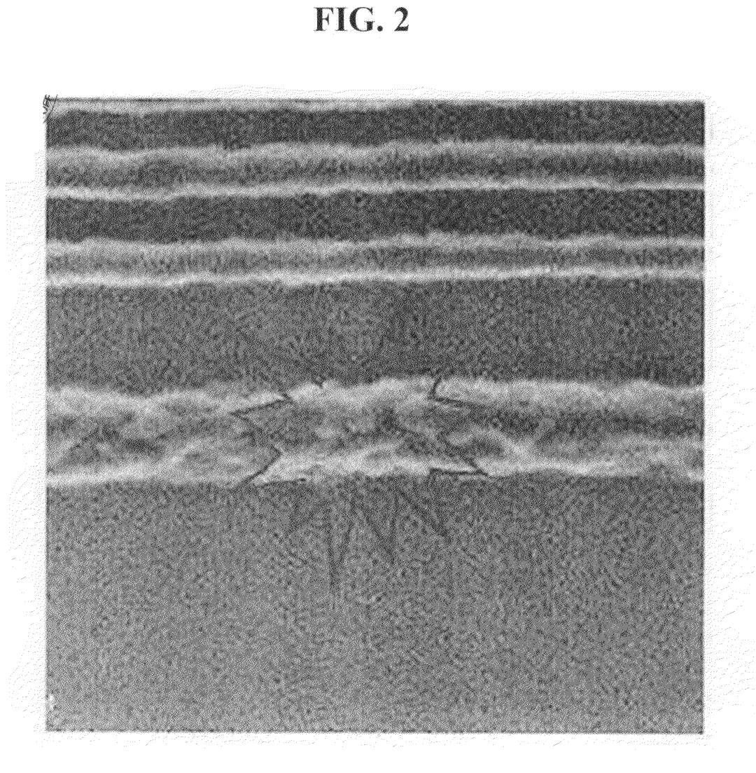

### DESCRIPTION OF SPECIFIC EMBODIMENTS

Now, a specific embodiment according to the disclosure is described with reference to the accompanying drawings.

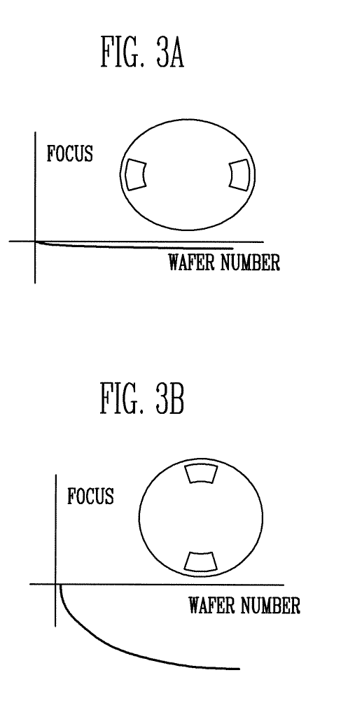

FIGS. 3A and 3B are graphs illustrating focus versus the number of wafers on which an exposure process has been performed when the dipole X-illumination system (FIG. 3A) and the dipole Y-illumination system (FIG. 3B) are used.

Referring to FIGS. 3A and 3B, in the exposure process of the semiconductor device, a pattern is formed from an X-direction mask in most cell mask processes. Thus, the stabilization system of the exposure apparatus is set to the X-direction cell mask. In this case, in the case of a scanner exposure apparatus, a scan direction is the Y-direction and the scanner exposure apparatus is optimized only in the X-direction. Accordingly, when the dipole X-illumination system is used, focus variations are small even with an increasing number of wafers, as compared to the focus variations resulting when the dipole Y-illumination system is used.

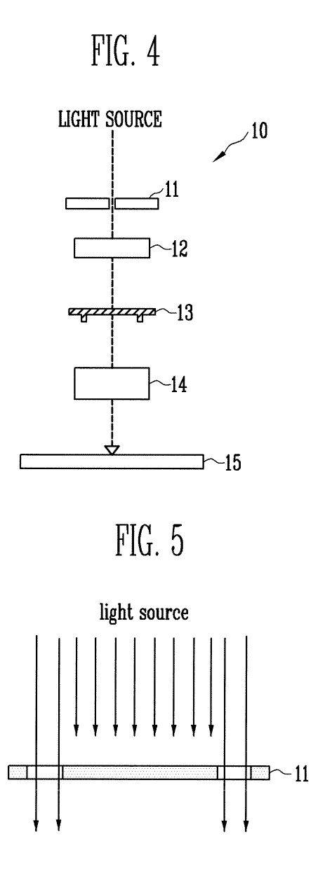

FIG. 4 illustrates an exposure apparatus according to an embodiment of the invention.

An exposure apparatus 10 includes a dipole X-illumination system 11 for receiving a light source and having only the light source of an X-direction pass therethrough, a lens 12 for focusing the light source passing through the dipole X-illumination system 11, a reticle stage 13 in which a reticle is mounted, an exposure lens 14 for irradiating the light source, passing through the reticle onto a wafer, and a wafer stage 15 on which the wafer is mounted.

An exposure method of a gate photo process of a semiconductor device according to an embodiment of the invention is described below with reference to the drawings.

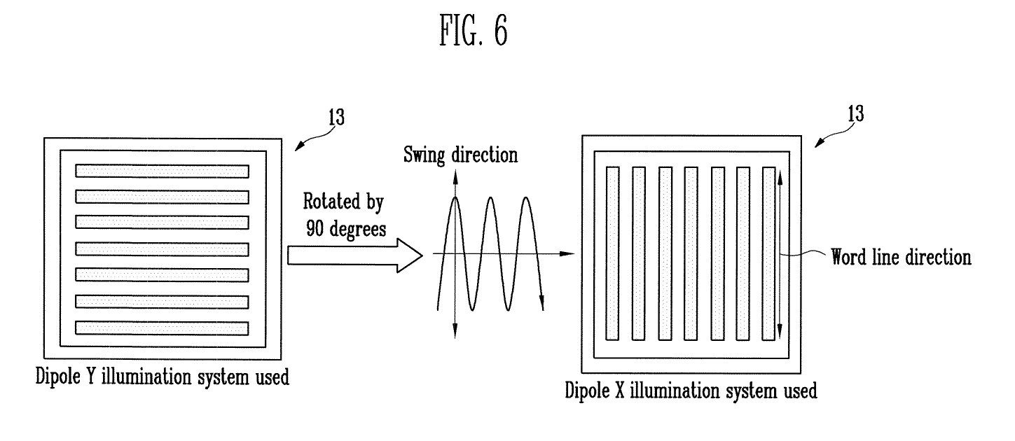

FIG. 5 is a view illustrating a state where a light source passes through the dipole X-illumination system.

Referring to FIGS. 4 and 5, the light source passing through the dipole X-illumination system passes through the lens 12 as light having the polarized light components of the X-direction and is then irradiated on the reticle. The light source is preferably one of I rays (365 nm), KrF (248 nm), ArF (193 nm), or EUV (157 nm; “extreme ultraviolet”).

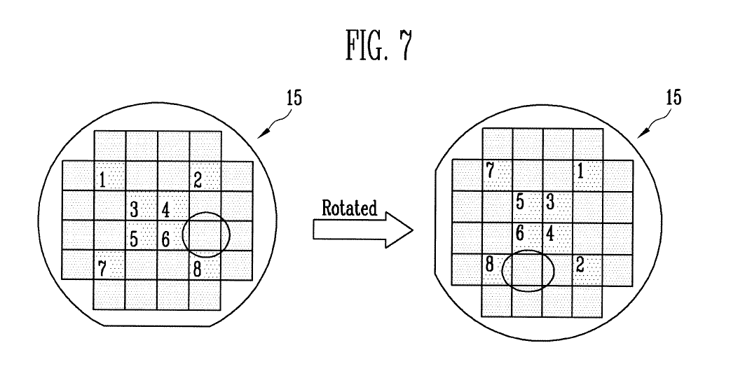

FIG. 6 illustrates a state where the reticle stage 13 has been rotated.

Referring to FIG. 6, the reticle stage 13 is rotated by 90 degrees in one direction and is then aligned. This aligns the reticle with a direction rotated 90 degrees relative to the dipole Y-illumination system in order to use the dipole X-illumination system instead of the dipole Y-illumination system. Preferably, this aligns the direction of the reticle with the swing direction of light passing through the dipole X-illumination system and irradiated on a pattern (e.g., a word line pattern) of the reticle.

FIG. 7 illustrates a state where the wafer stage 15 has been rotated.

Preferably, the reticle stage 13 and the wafer stage 15 are rotated and aligned in the same direction. As illustrated in FIG. 7, the wafer stage 15 is rotated 90 degrees in the same direction that the reticle stage 13 is rotated and is then aligned. This aligns the reticle with a direction rotated 90 degrees relative to the dipole Y-illumination system in order to use the dipole X-illumination system instead of the dipole Y-illumination system. Preferably, the wafer stage 15 is rotated such that the swing direction of light passing through the reticle is identical to the direction of word lines formed on the wafer.

In general, the wafer is aligned by using eight alignment keys in the X- and Y-directions, respectively. Coordinates in each of the X- and Y-directions upon alignment are aligned by using coordinates changed by rotation. The light source passing through the reticle stage 13 is irradiated on the wafer disposed on the wafer stage 15 using the exposure lens 14, and the exposure process is then performed.

The above-mentioned reticle and wafer are aligned after being rotated. This controls the fluctuation of the stage, which may occur upon rotation.

As described above, in the gate photo process, the light source is irradiated by using the dipole X-illumination system, and the process is changed to the same process as when the dipole Y-illumination system is used by rotating the reticle and the wafer by 90 degrees in one direction. It is therefore possible to perform an exposure process without heating the exposure lens. Accordingly, pattern failure due to a heated exposure lens can be prevented.

As described above, according to the invention, in a gate photo process of a semiconductor device, an exposure process is performed by using a dipole X-illumination system instead of a dipole Y-illumination system and is also performed by rotating a reticle stage and a wafer stage for wafer alignment by 90 degrees. Accordingly, although the number of wafers is increased, the occurrence of pattern failure due to a heated lens can be prevented.

Although the foregoing description has been made with reference to a specific embodiment, it is to be understood that changes and modifications may be made by the ordinarily skilled artisan without departing from the spirit and scope of the disclosure and appended claims.

What is claimed is:

1. An exposure method of a semiconductor device, comprising the steps of:
providing a wafer comprising a photoresist coated on the wafer;
rotating and aligning a reticle and the wafer so that a swing direction of a light source passing through the reticle is aligned with a direction of a word line formed on the wafer; and
performing an exposure process employing a polarized light source of an X-direction, the polarized light source being generated by passing the light source through a dipole X-illumination system.

2. The exposure method of claim 1, wherein the light source is selected from the group consisting of I rays (365 nm), KrF (248 nm), ArF (193 nm), and EUV (157 nm).

3. The exposure method of claim 1, wherein the step of rotating and aligning the reticle and the wafer comprises rotating and aligning the reticle and the wafer in the same direction.

4. The exposure method of claim 1, wherein the step of aligning the reticle and the wafer comprises rotating each of the reticle and the wafer 90 degrees in the same direction relative to a dipole Y-illumination system.

5. The exposure method of claim 1, wherein the step of performing the exposure process comprises the steps of:
passing the light source through the dipole X-illumination system and outputting the polarized light source of the X-direction;
irradiating the polarized light source on the reticle so that the polarized light source passes through the reticle;
passing the polarized light source passing through the reticle through an exposure lens and focusing the polarized light source; and
irradiating the polarized light source passing through the exposure lens onto the wafer.
